(19) United States
(12) Patent Application Publication
(10) Pub. No.: US 2026/0312846 A1
(43) Pub. Date: Oct. 8, 2026

(54) DYNAMIC SCRAMBLING FOR WIRED COMMUNICATIONS BETWEEN SYSTEMS

(71) Applicant: Micron Technology, Inc., Boise, ID (US)

(72) Inventors: Scott E. Schaefer, Boise, ID (US); Navid Lashkarian, Pleasanton, CA (US)

(21) Appl. No.: 19/572,391

(22) Filed: Mar. 19, 2026

Related U.S. Application Data
(60) Provisional application No. 63/782,448, filed on Apr. 2, 2025.

(51) Int. Cl. H04L 25/03; H04L 1/00

(52) U.S. Cl. CPC H04L 25/03866; H04L 1/0041; H04L 1/0086

(57) ABSTRACT

Methods, systems, and devices for dynamic scrambling for wired communications between systems are described. A host system may transmit a first packet of data bits to a memory system. The host system may receive an indication that the memory system received the first packet with a threshold quantity of one or more errors. Based on receiving the indication, the host system may apply a scrambling pattern to a second packet of the data bits. The host system may then transmit the second data packet to the memory system based on applying the scrambling pattern to the second data packet.

### CROSS REFERENCE

The present Application for Patent claims priority to U.S. Patent Application No. 63/782,448 by Schaefer et al., entitled “DYNAMIC SCRAMBLING FOR WIRED COMMUNICATIONS BETWEEN SYSTEMS,” filed Apr. 2, 2025, which is assigned to the assignee hereof, and which is expressly incorporated by reference in its entirety herein.

### TECHNICAL FIELD

The following relates to one or more systems for memory, including dynamic scrambling for wired communications between systems.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports dynamic scrambling for wired communications between systems in accordance with examples as disclosed herein.

FIG. 2 shows an example of an apparatus that supports dynamic scrambling for wired communications between systems in accordance with examples as disclosed herein.

FIG. 3 shows an example of a process flow that supports dynamic scrambling for wired communications between systems in accordance with examples as disclosed herein.

FIG. 4 shows a block diagram of a host system that supports dynamic scrambling for wired communications between systems in accordance with examples as disclosed herein.

FIG. 5 shows a block diagram of a memory system that supports dynamic scrambling for wired communications between systems in accordance with examples as disclosed herein.

FIGS. 6 and 7 show flowcharts illustrating a method or methods that support dynamic scrambling for wired communications between systems in accordance with examples as disclosed herein.

### DETAILED DESCRIPTION

A memory system and a host system may communicate information over a communication link (e.g., a bus) between the memory system and the host system. For example, the host system may transmit a packet comprising binary information to the memory system over the communication link. But the pattern of 0s and 1s in the packet may render the packet susceptible to corrupting phenomena such as inter-symbol interference (ISI) during propagation over the communication link. If a corrupting phenomenon is sufficiently severe, the packet may be received by the memory system with a quantity of one or more errors referred to as link errors. If the quantity of errors exceeds the correction capabilities of the memory system, the memory system may request retransmission of the packet from the host system. But the retransmission of the packet may experience the same corrupting phenomenon because the pattern of 0s and 1s is the same as in the original transmission.

According to the techniques described herein, link errors for a retransmitted packet may be reduced by applying a scrambling pattern to the packet before re-transmitting the packet. Applying the scrambling pattern may modify the bits in the packet so that the packet is less susceptible to the corrupting phenomenon that caused errors in an original transmission of the packet. To ensure that the memory system (or other recipient system) is able to descramble the packet and obtain the information, the host system (or other transmitting system) may indicate the scrambling pattern used for the retransmitted packet. In some examples, an initial scrambling pattern may be applied to the packet before the original transmission of the packet. In such examples, the initial scrambling pattern may be a default scrambling pattern or a scrambling pattern selected based on the packet having one or more bit pattern characteristics associated with link errors.

In addition to applicability in memory systems as described herein, techniques for dynamic scrambling for inter-system communications may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing communication errors, among other benefits.

In addition to applicability in memory systems as described herein, techniques for dynamic scrambling for inter-system communications may be generally implemented to support increased connectivity of electronic systems. As the use of systems relying on interconnected electronic devices increases, the connectivity of these electronic devices becomes an increasingly relevant factor for the operations of the system. For example, delays associated with signals communicated between devices may become increasingly relevant as critical systems come to rely more on connectivity, as a system uses larger quantities of interconnected devices, or if the quantity and the complexity of signals communicated between devices increases. Implementing the techniques described herein may support techniques for increased connectivity in electronic systems by reducing communication errors, among other benefits.

Features of the disclosure are illustrated and described in the context of systems and architectures. Features of the disclosure are further illustrated and described in the context of systems, a process flow, device diagrams, and flowcharts.

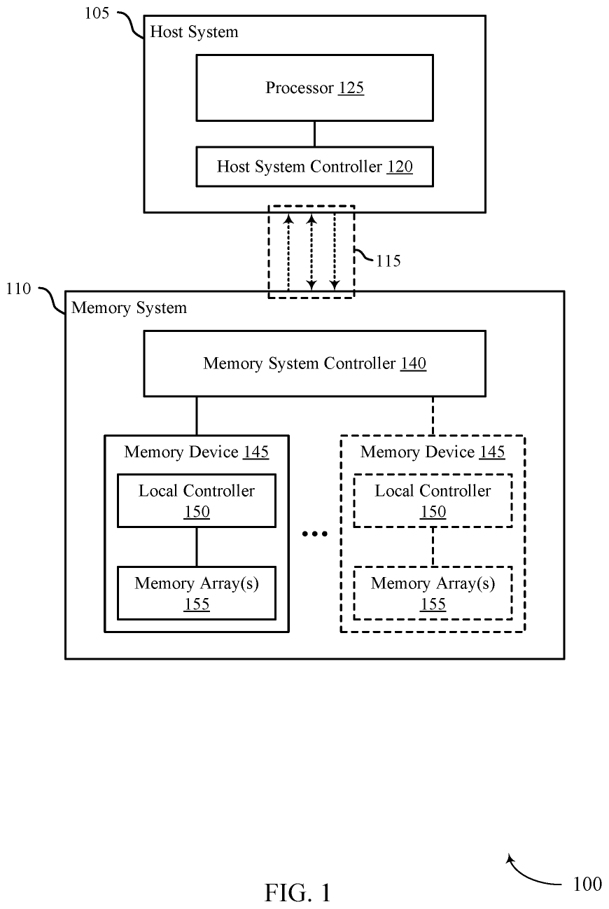

FIG. 1 shows an example of a system 100 that supports dynamic scrambling for wired communications between systems in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

As the system 100 operates, the host system 105 and the memory system 110 may communicate information in packets that are transmitted over one or more communication links (e.g., buses, channels 115). The packets may may include data bits and error protection bits, such as error correction code (ECC) bits or cyclic redundancy check (CRC) bits. A packet may also be referred to as a codeword or other suitable terminology. ECC bits may enable detection and correction of one or more errors, depending on the strength of the ECC scheme, whereas CRC bits may enable detection of one or more errors (but not necessarily correction). In either case, the memory system 110 may be capable of correcting a threshold quantity of errors (in the case of CRC, the threshold quantity may be zero, one, or more than one).

If the memory system 110 receives a packet with a quantity of errors that exceeds the threshold quantity of errors the memory system 110 is capable of correcting, the memory system 110 may request that the host system 105 re-transmit the packet. But if the error(s) in the packet were link errors related to the bit-pattern of the packet (e.g., ISI-caused errors), the re-transmitted packet may encounter the same errors as the original packet. To prevent re-occurrence of link errors for packet re-transmissions, the memory system 110 may apply a scrambling pattern to the packet before re-transmitting the packet. In some cases, the host system 105 may attempt to prevent link errors in the first place by applying an initial scrambling pattern to the packet before the original transmission (e.g., if the packet has a bit pattern associated with link errors). If the memory system 110 requests re-transmission of the packet, the host system 105 may apply a new scrambling pattern to the packet before transmitting the packet.

A packet may also be referred to as a data packet or other suitable terminology. A scrambling pattern may also be referred to as a scrambling code or other suitable terminology. Although described with reference to the host system 105 as the transmitting system and the memory system 110 as the receiving system, the roles of the host system 105 and the memory system 110 may be reversed.

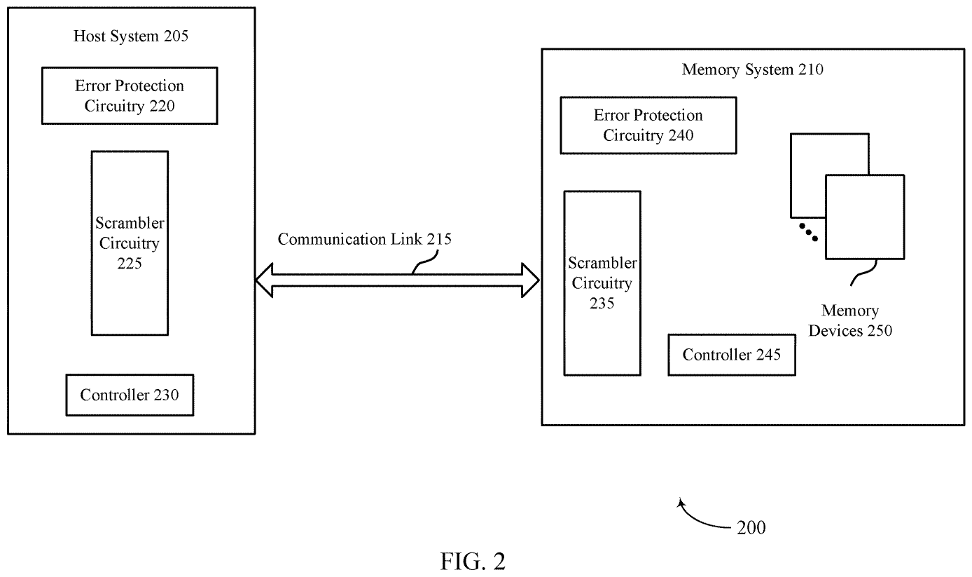

FIG. 2 illustrates an example of a system 200 that supports dynamic scrambling for wired communications between systems in accordance with examples as disclosed herein. The system 200 may include a host system 205 and a memory system 210. The host system 205 may be an example of the host system 105 as described with reference to FIG. 1, and the memory system 210 may be an example of a memory system 110 as described with reference to FIG. 1. The host system 205 and the memory system 210 may communicate over a communication link 215 that is coupled with the host system 205 and the memory system 210. According to the techniques describe herein, the host system 205 may apply scrambling patterns to packets before transmitting the packets to the memory system 210 over the communication link 215.

The host system 205 may include error protection circuitry 220, which may be configured to generate error protection bits for data. In some examples, the error protection circuitry 220 may include ECC circuitry that is configured to generate error protection bits (e.g., parity bits) for data based on the data (e.g., the parity bits may be a function of the data bits). In some examples, the error protection circuitry 220 may include CRC circuitry that is configured to generate error protection bits (e.g., CRC bits) for data that are based on the data (e.g., the CRC bits may be a function of the data bits). The error protection bits generated by the error protection circuitry 220 may be appended to the data (e.g., data for writing to the memory device 250) to form a packet that is transmitted over the communication link 215. Thus, the packets transmitted over the communication link 215 may include data bits and error protection bits that are based on the data bits.

In some examples, if the bit error rate (BER) is sufficiently low such that the likelihood of two or more errors is negligible, a simplified correction mechanism based on list/syndrome decoding can correct the single bit errors. In some examples, a stronger decoder such as a guessing random noise decoder may be used to correct multi-bit errors in a codeword.

The host system 205 may include scrambler circuitry 225, which may be configured to apply scrambling patterns to packets for transmission over the communication link 215. For example, the scrambler circuitry 225 may receive a packet from the error protection circuitry 220, apply a scrambling pattern to the packet (e.g., to both the data bits and the error protection bits), and output the scrambled packet for transmission over the communication link 215. Applying the scrambling pattern may modify (e.g., change the values of) the bits in the packet so that the packet is less susceptible to the corrupting phenomenon that caused errors in an original transmission of the packet. In some examples, the scrambling pattern applied to a packet may be selected from a table of scrambling patterns. In some examples, the scrambling pattern applied to a packet may be based on the bit pattern of the bits in the packet. The scrambler circuitry 225 may also be configured to apply descrambling patterns to received packets (e.g., in the event that the memory system 210 applies a scrambling pattern to the packets).

Although described with reference to the scrambling pattern being applied to an error-protected packet from the error protection circuitry 220, in some examples the scrambling pattern may be applied to the data bits in a packet before error protection bits are added to the packet. In such examples, the error protection bits may be based on the scrambled data bits. At the memory system 210, error detection and correction may be performed on the packet before descrambling the data bits.

The host system may include a controller 230, which may be configured to control operations of the scrambler circuitry 225 and other components of the host system 205. For example, the controller 230 may determine whether the scrambler circuitry 225 is to apply a scrambling pattern to a packet, may select a scrambling pattern for the packet, or both. In some examples, the controller 230 may determine to apply a scrambling pattern to a packet based on the packet the host system 205 receiving a request for re-transmission of the packet. If the packet was scrambled with a first scrambling pattern for the previous transmission, the controller 230 may select a second scrambling pattern for the re-transmission. In some examples, the controller 230 may determine to apply a scrambling pattern to a packet based on the pattern of bits in the packet having one or more characteristics associated with link errors. For example, the controller 230 may track the error status of packets transmitted over the communication link 215 and determine bit pattern characteristics that are associated with link errors. In some examples, the controller 230 may include a machine learning (ML) or artificial intelligence (AI) engine that performs the bit pattern analysis.

In some examples, the controller 230 may select a scrambling pattern for a packet based on the bit pattern of the packet. For example, the controller 230 may determine that the bit pattern of the packet has one or more characteristics associated with link errors and may select a scrambling pattern that is associated with the one or more characteristics. In some examples, the controller 230 may include a table that maps bit pattern characteristics to scrambling patterns. In such examples, a scrambling pattern for a packet may be selected from the table based on the scrambling pattern being mapped to the bit pattern of the packet. The bit pattern of a packet may refer to the pattern of data bits in the packet or to the pattern of the data bits and the error correction bits in the packet.

If a scrambling pattern is applied to a packet, the host system 205 may send an indication of the scrambling pattern to the memory system 210 so that the memory system 210 can apply the corresponding descrambling pattern to the packet (and thus recover the original bits). In some examples, the indication of the scrambling pattern may indicate a quantity of packets (e.g., n packets) to which the scrambling pattern applies. In some examples, the indication of the scrambling pattern may indicate a duration for which the scrambling pattern applies.

The memory system 210 may include one or more memory devices 250, which may be examples of a memory device 145 as described with reference to FIG. 1. Data received from the host system 205 may be stored in the memory device(s) 250 and returned to the host system 205 upon request. The data from the host system 205 may be received in one or more packets which may be applied with a scrambling pattern as described herein. Before storing the data in the memory devices 250, the memory system 210 may descramble the packet and perform error detection (and potentially error correction). In some examples, the data returned to the host system 205 may be transmitted in one or more packets which may be applied with a scrambling pattern as described herein.

The memory system 210 may include error protection circuitry 240, which may be configured to detect, and potentially correct, errors in packets received over the communication link 215. For example, the error protection circuitry 240 may use the error protection bits in a packet to determine whether the packet has any errors. If the quantity of errors detected in a packet is less than or equal to the threshold quantity of errors that the memory system 210 is capable of correcting, the error protection circuitry 240 may use the error protection bits to correct the quantity of errors. In some examples, the error protection circuitry 220 may include ECC circuitry that is configured to use parity bits for error detection and correction. In some examples, the error protection circuitry 220 may include CRC circuitry that is configured to use CRC bits for error detection. In some examples, the error protection circuitry 240 may be configured to generate error protection bits for data in a manner similar to the error protection circuitry 220.

The memory system 210 may be configured to request retransmission of a packet if the packet is received with a quantity of errors that exceeds the error correction capability of the memory system 210. For example, if the memory system 210 is capable of correcting k errors per packet and a received packet as k+1 errors, the memory system 210 may transmit to the host system 205 a request for retransmission of the packet.

The memory system 210 may include scrambler circuitry 235. The scrambler circuitry 235 may be configured to apply descrambling patterns to packets received from the host system 205 over the communication link 215. For example, the scrambler circuitry 235 may receive a packet from a transceiver coupled with the communication link 215, apply a descrambling pattern to the packet, and output the descrambled packet to the error protection circuitry 240 for error detection, error correction, or both. Alternatively, the scrambler circuitry 235 may receive the data bits of a packet from the error protection circuitry 240 (e.g., after error detection and/or correction) and apply a descrambling pattern to the data bits. In some examples, the descrambling pattern applied to a packet may be based on an indication of the scrambling pattern used by the host system 205 to scramble the packet. The scrambler circuitry 225 may also be configured to apply scrambling patterns to packets (e.g., packets of data read from the memory devices 250) for transmission over the communication link 215.

The memory system 210 may include a controller 245, which may be configured to control operations of the scrambler circuitry 235. For example, the controller 245 may determine whether to apply a descrambling pattern to a received packet and if so, which descrambling pattern to apply. The controller 245 may determine to apply a descrambling pattern to a packet based on a determination that the packet is scrambled with a scrambling pattern.

In some examples, the controller 245 may determine that a packet is scrambled with a scrambling pattern based on an indication from the host system 205 that the packet is scrambled with a scrambling pattern. The indication may be specific to the packet or may indicate a set of packets (to which the packet belongs) that are scrambled with a scrambling pattern. For example, if the host system 205 indicates a quantity of packets (e.g., the next n packets for transmission) to which a scrambling pattern applies, the controller 245 may determine to apply a descrambling pattern to a packet if the packet is included in the n quantity of packets. If the host system 205 indicates a duration for which a scrambling pattern applies, the controller 245 may determine to apply a descrambling pattern to a packet if the packet is received during the duration.

The controller 245 may select a descrambling pattern for applying to the packet based on an indication of a descrambling pattern associated with the packet. Alternatively, the controller 245 may select a descrambling pattern for applying to the packet based on an indication of the scrambling pattern applied to the packet. For example, the controller 245 may select a scrambling pattern that corresponds to the scrambling pattern. In some examples, the controller 245 may be configured (similar to the controller 230) to control the application of scrambling patterns to packets for transmission over the communication link 215.

Thus, the system 200 may support the use of scrambling patterns to reduce link errors for packets transmitted over the communication link 215. For example, the memory system 210 may assert a link-error signal and request the host system 205 to retransmit the information. To add robustness to the correlated noise, the retransmission can be done using a scrambled version of the information bits. This randomness can potentially improve the likelihood of correct detection during retransmission.

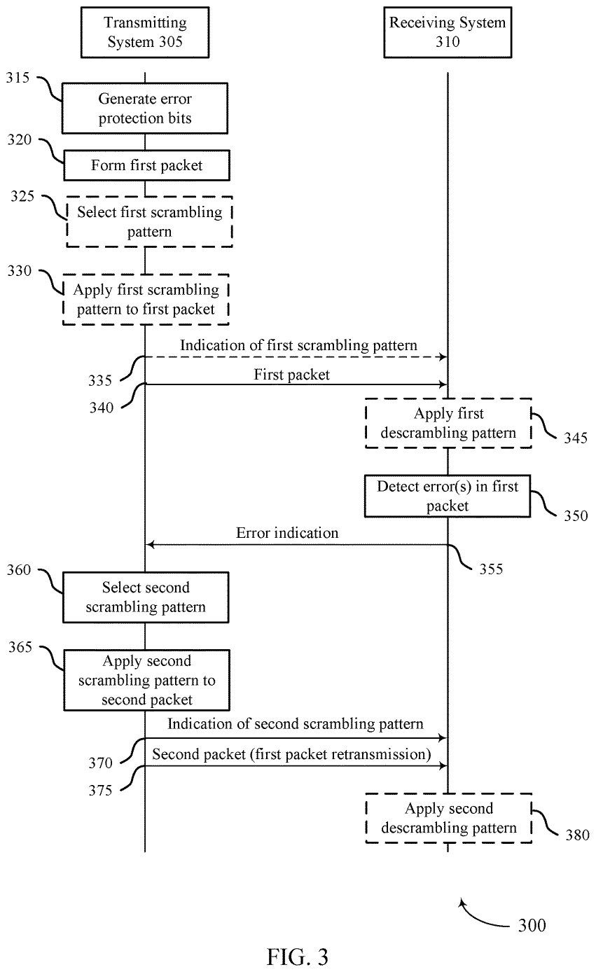

FIG. 3 shows an example of a process flow 300 that supports dynamic scrambling for wired communications between systems in accordance with examples as disclosed herein. The process flow 300 may be implemented by a transmitting system 305 and a receiving system 310. The transmitting system 305 may be an example of the host system 205, in which case the receiving system 310 may be an example of the memory system 210. Alternatively, the transmitting system 305 may be an example of the memory system 210, in which case the receiving system 310 may be an example of the host system 205.

At 315, the transmitting system 305 may generate error protection bits for data bits that are received or queued for transmission to the receiving system 310. For example, the transmitting system 305 may generate ECC bits or CRC bits based on the data bits. At 320, the transmitting system 305 may form a first packet that includes the data bits and the error protection bits.

At 325, the transmitting system 305 may select a first scrambling pattern for the first packet. In some examples, the first scrambling pattern may be selected based on determining that a bit pattern of the first packet (e.g., a bit pattern of the data bits, a bit pattern of the data bits and the error protection bits) has one or more characteristics associated with link errors. In such examples, the transmitting system 305 may select the first scrambling pattern based on the scrambling pattern being associated with the one or more characteristics of the bits pattern. In some examples, the transmitting system 305 may select a default scrambling pattern as the first scrambling pattern. In some examples, the transmitting system 305 may select the scrambling pattern based on the scrambling pattern being associated with the application (e.g., a software application) from which the data bits originated.

At 330, the transmitting system 305 may apply the first scrambling pattern to the first packet. At 335, the transmitting system 305 may transmit an indication of the first scrambling pattern (or an indication of a first descrambling pattern corresponding to the scrambling pattern) to the receiving system 310. At 340, the transmitting system 305 may transmit the first packet to the receiving system 310.

At 345, the receiving system 310 may apply the first descrambling pattern to the first packet. The first descrambling pattern may correspond to the first scrambling pattern in that the first descrambling pattern may undo the first scrambling pattern (e.g., the first descrambling pattern may restore the bits of the first packet to their original (e.g., pre-scrambling) values). The receiving system 310 may select the first descrambling pattern based on an indication of the first scrambling pattern or an indication of the first descrambling pattern received from the transmitting system 305 at 335.

At 350, the receiving system 310 may detect a quantity of one or more errors in the first packet. The receiving system 310 may detect the quantity of errors based on the error protection bits in the first packet (e.g., by performing ECC or CRC decoding on the packet).

At 355, the receiving system 310 may transmit an indication of the quantity of errors to the transmitting system 305. The receiving system 310 may transmit the error indication based on the quantity of errors exceeding the error correction capability of the receiving system 310. The error indication may serve as a request for retransmission of the first packet. Alternatively, the receiving system 310 may transmit a request for retransmission of the first packet.

At 360, the transmitting system 305 may select a second scrambling pattern for a second packet that is a retransmission of the first packet. That is, the second packet may have the same data bits and error protection bits as the first packet. In some examples, the second scrambling pattern may be selected based on the first scrambling pattern (e.g., the second scrambling pattern may be next to the first scrambling pattern in a table of scrambling patterns). In some examples (e.g., if the first packet is not applied with the first scrambling pattern), the second scrambling pattern may be selected based on determining that a bit pattern of the second packet (e.g., a bit pattern of the data bits, a bit pattern of the data bits and the error protection bits) has one or more characteristics associated with link errors. In such examples, the transmitting system 305 may select the second scrambling pattern based on the scrambling pattern being associated with the one or more characteristics of the bit pattern. In some examples, the transmitting system 305 may select a second default scrambling pattern as the second scrambling pattern.

At 365, the transmitting system 305 may apply the second scrambling pattern to the second packet. At 370, the transmitting system 305 may transmit an indication of the second scrambling pattern (or an indication of a second descrambling pattern corresponding to the second scrambling pattern) to the receiving system 310. At 375, the transmitting system 305 may transmit the second packet to the receiving system 310.

At 380, the receiving system 310 may apply the second descrambling pattern to the second packet. The second descrambling pattern may correspond to the second scrambling pattern in that the first descrambling pattern may undo the second scrambling pattern (e.g., the second descrambling pattern may restore the bits of the second packet to their original (e.g., pre-scrambling) values). The receiving system 310 may select the second descrambling pattern based on an indication of the second scrambling pattern or an indication of the second descrambling pattern received from the transmitting system 305 at 370. In some examples, the receiving system 310 may detect and correct a quantity of one or more errors in the second packet. The receiving system 310 may detect and correct the quantity of errors based on the error protection bits in the second packet (e.g., by performing ECC or CRC decoding on the packet).

Thus, scrambling patterns may be used to reduce the likelihood of link errors between systems.

In some examples, the scrambling patterns may be applied to the data bits of a packet before generating the error protection bits and forming the packet. For example, the transmitting system 305 may apply the first scrambling pattern to the data bits for the first packet, then generate first error protection bits based on the scrambled data bits. So, the first packet may include the scrambled data bits and the first error protection bits. In such an example, the receiving system 310 may detect the quantity of errors in the first packet before applying the first descrambling pattern to the data bits of the first packet. That is, error detection and correction for the first packet may occur before descrambling the data bits of the first packet.

Continuing the example, the transmitting system 305 may apply the second scrambling pattern to the data bits of the second packet, then generate second error protection bits based on the scrambled data bits. So, the second packet may include the scrambled data bits and the second error protection bits, which may be different than the first error protection bits (because the underlying data bits have been applied with a different scrambling pattern). In such an example, the receiving system 310 may detect the quantity of errors in the second packet before applying the second descrambling pattern to the data bits of the second packet. That is, error detection and correction for the second packet may occur before descrambling the data bits of the second packet.

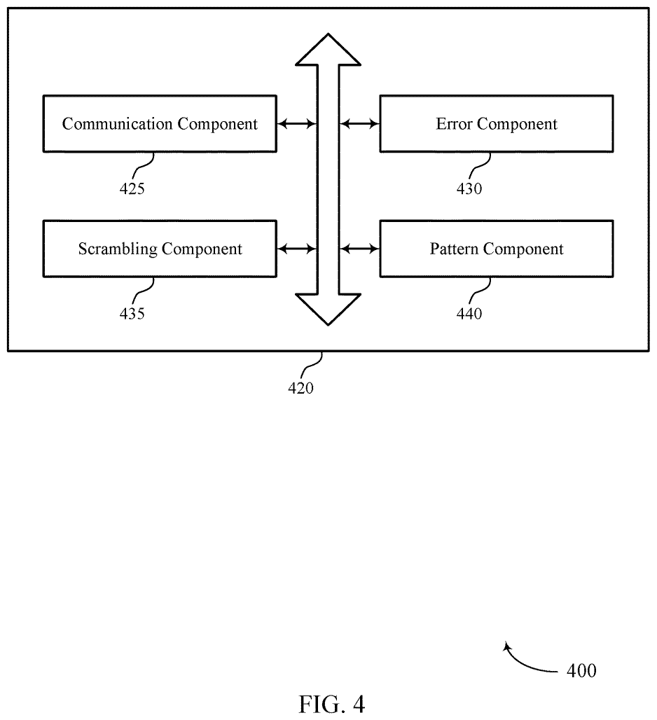

FIG. 4 shows a block diagram 400 of a host system 420 that supports dynamic scrambling for wired communications between systems in accordance with examples as disclosed herein. The host system 420 may be an example of aspects of a host system as described with reference to FIGS. 1 through 3. The host system 420, or various components thereof, may be an example of means for performing (e.g., to cause the host system 420 to perform) various aspects of dynamic scrambling for wired communications between systems as described herein. For example, the host system 420 may include a communication component 425, an error component 430, a scrambling component 435, a pattern component 440, or any combination thereof. Each of these components, or components of subcomponents thereof (e.g., one or more processors, one or more memories), may communicate, directly or indirectly, with one another (e.g., via one or more buses).

The communication component 425 may be configured as or otherwise support a means for transmitting a first data packet to a memory system, the first data packet including data bits and one or more error protection bits. The error component 430 may be configured as or otherwise support a means for receiving an error indication for the first data packet, the error indication indicating that the memory system received the first data packet with a threshold quantity of one or more errors. The scrambling component 435 may be configured as or otherwise support a means for applying, based at least in part on receiving the error indication, a scrambling pattern to a second data packet that includes the data bits and the one or more error protection bits of the first data packet. In some examples, the communication component 425 may be configured as or otherwise support a means for transmitting the second data packet to the memory system based at least in part on applying the scrambling pattern to the second data packet.

In some examples, the scrambling component 435 may be configured as or otherwise support a means for applying a second scrambling pattern to the first data packet, where the scrambling pattern applied to the second data packet is different than the second scrambling pattern applied to the first data packet, where transmitting the first data packet is based at least in part on applying the second scrambling pattern.

In some examples, the pattern component 440 may be configured as or otherwise support a means for determining one or more characteristics of data patterns that are associated with errors introduced into data communicated over a communication link between the host system and the memory system. In some examples, the pattern component 440 may be configured as or otherwise support a means for determining that a data pattern of the data bits has at least one of the one or more characteristics, where the second scrambling pattern is applied to the first data packet based at least in part on the data pattern having at least one of the one or more characteristics.

In some examples, the communication component 425 may be configured as or otherwise support a means for transmitting an indication of the second scrambling pattern to the memory system based at least in part on applying the second scrambling pattern to the first data packet. In some examples, the communication component 425 may be configured as or otherwise support a means for transmitting an indication of the scrambling pattern to the memory system based at least in part on applying the scrambling pattern.

In some examples, the scrambling component 435 may be configured as or otherwise support a means for applying, based at least in part on the second data packet being a retransmission of the data bits and the one or more error protection bits, the second scrambling pattern to a third data packet that includes second data bits and one or more second error protection bits. In some examples, the communication component 425 may be configured as or otherwise support a means for transmitting the third data packet to the memory system based at least in part on applying the second scrambling pattern to the third data packet.

In some examples, the scrambling component 435 may be configured as or otherwise support a means for applying, based at least in part on applying the scrambling pattern to the second data packet, the scrambling pattern to a third data packet that includes second data bits and one or more second error protection bits. In some examples, the communication component 425 may be configured as or otherwise support a means for transmitting the third data packet to the memory system based at least in part on applying the scrambling pattern to the third data packet.

In some examples, the pattern component 440 may be configured as or otherwise support a means for determining one or more characteristics of data patterns that are associated with errors introduced into data communicated over a communication link between the host system and the memory system. In some examples, the pattern component 440 may be configured as or otherwise support a means for selecting the scrambling pattern based at least in part on determining that a data pattern of the data bits has at least one of the one or more characteristics.

In some examples, the communication component 425 may be configured as or otherwise support a means for transmitting an indication of the scrambling pattern to the memory system based at least in part on applying the scrambling pattern to the first data packet.

In some examples, the error component 430 may be configured as or otherwise support a means for generating the one or more error protection bits based at least in part on the data bits, where the one or more error protection bits include CRC bits or error correction code (ECC) bits.

In some examples, the described functionality of the host system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements) that are configured to cause the host system 420 to perform one or more operations. In some examples, the described functionality of the host system 420, or various components thereof, may be implemented at least in part by instructions (e.g., stored in memory, non-transitory computer-readable medium) executable by such at least one processor to cause the host system 420 to perform one or more operations.

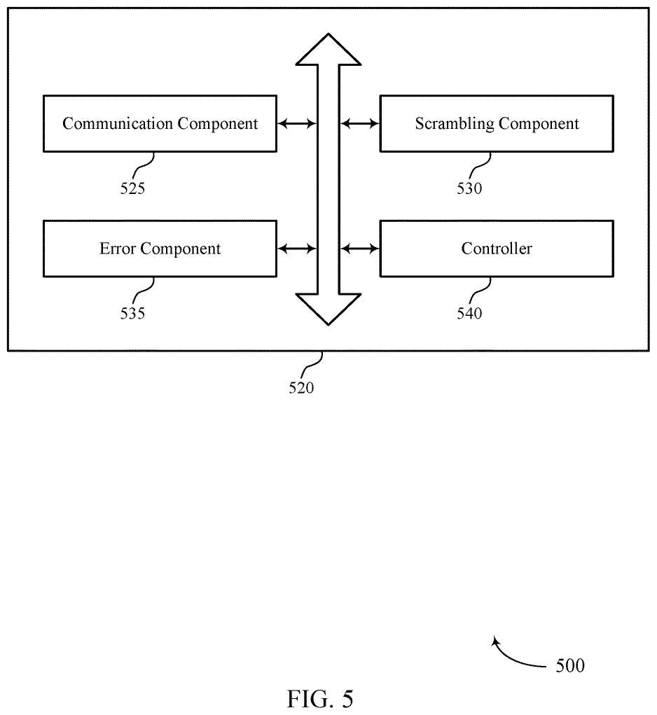

FIG. 5 shows a block diagram 500 of a memory system 520 that supports dynamic scrambling for wired communications between systems in accordance with examples as disclosed herein. The memory system 520 may be an example of aspects of a memory system as described with reference to FIGS. 1 through 3. The memory system 520, or various components thereof, may be an example of means for performing (e.g., to cause the memory system 520 to perform) various aspects of dynamic scrambling for wired communications between systems as described herein. For example, the memory system 520 may include a communication component 525, a scrambling component 530, an error component 535, a controller 540, or any combination thereof. Each of these components, or components of subcomponents thereof (e.g., one or more processors, one or more memories), may communicate, directly or indirectly, with one another (e.g., via one or more buses).

The communication component 525 may be configured as or otherwise support a means for receiving a first data packet including data bits and one or more error protection bits. In some examples, the communication component 525 may be configured as or otherwise support a means for transmitting an error indication for the first data packet based at least in part on receiving the first data packet with a threshold quantity of one or more errors. In some examples, the communication component 525 may be configured as or otherwise support a means for receiving, based at least in part on transmitting the error indication, a second data packet that is scrambled with a scrambling pattern, the second data packet including the data bits and the one or more error protection bits of the first data packet. The scrambling component 530 may be configured as or otherwise support a means for applying a descrambling pattern to the second data packet based at least in part on the scrambling pattern.

In some examples, the scrambling component 530 may be configured as or otherwise support a means for applying a second descrambling pattern to the first data packet, where the descrambling pattern applied to the second data packet is different than the second descrambling pattern applied to the first data packet.

In some examples, the communication component 525 may be configured as or otherwise support a means for receiving an indication of a second scrambling pattern associated with the second descrambling pattern. In some examples, the controller 540 may be configured as or otherwise support a means for selecting the second descrambling pattern based at least in part on the indication of the second scrambling pattern.

In some examples, the communication component 525 may be configured as or otherwise support a means for receiving a third data packet after applying the descrambling pattern to the second data packet, the third data packet including second data bits and one or more second error protection bits. In some examples, the scrambling component 530 may be configured as or otherwise support a means for applying the second descrambling pattern to the third data packet based at least in part on the second data packet being a retransmission of the data bits and the one or more error protection bits.

In some examples, the communication component 525 may be configured as or otherwise support a means for receiving a third data packet after applying the descrambling pattern to the second data packet, the third data packet including second data bits and one or more second error protection bits. In some examples, the scrambling component 530 may be configured as or otherwise support a means for applying the descrambling pattern to the third data packet.

In some examples, the communication component 525 may be configured as or otherwise support a means for receiving an indication of the scrambling pattern applied to the second data packet, where the descrambling pattern is applied based at least in part on the indication.

In some examples, the error component 535 may be configured as or otherwise support a means for determining that the first data packet was received with the threshold quantity of one or more errors based at least in part on the one or more error protection bits, where the one or more error protection bits include CRC bits or error correction code (ECC) bits.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements) that are configured to cause the memory system 520 to perform one or more operations. In some examples, the described functionality of the memory system 520, or various components thereof, may be implemented at least in part by instructions (e.g., stored in memory, non-transitory computer-readable medium) executable by such at least one processor to cause the memory system 520 to perform one or more operations.

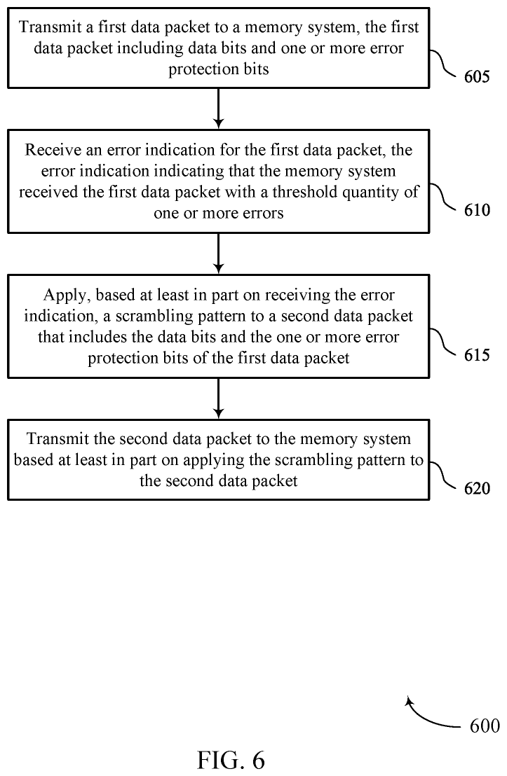

FIG. 6 shows a flowchart illustrating a method 600 that supports dynamic scrambling for wired communications between systems in accordance with examples as disclosed herein. The operations of method 600 may be implemented by a host system or its components as described herein. For example, the operations of method 600 may be performed by a host system as described with reference to FIGS. 1 through 4. In some examples, a host system may execute a set of instructions to control the functional elements of the device to perform the described functions. Additionally, or alternatively, the host system may perform aspects of the described functions using special-purpose hardware.

At 605, the method may include transmitting a first data packet to a memory system, the first data packet including data bits and one or more error protection bits. In some examples, aspects of the operations of 605 may be performed by a communication component 425.

At 610, the method may include receiving an error indication for the first data packet, the error indication indicating that the memory system received the first data packet with a threshold quantity of one or more errors. In some examples, aspects of the operations of 610 may be performed by an error component 430.

At 615, the method may include applying, based at least in part on receiving the error indication, a scrambling pattern to a second data packet that includes the data bits and the one or more error protection bits of the first data packet. In some examples, aspects of the operations of 615 may be performed by a scrambling component 435.

At 620, the method may include transmitting the second data packet to the memory system based at least in part on applying the scrambling pattern to the second data packet. In some examples, aspects of the operations of 620 may be performed by a communication component 425.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for transmitting a first data packet to a memory system, the first data packet including data bits and one or more error protection bits; receiving an error indication for the first data packet, the error indication indicating that the memory system received the first data packet with a threshold quantity of one or more errors; applying, based at least in part on receiving the error indication, a scrambling pattern to a second data packet that includes the data bits and the one or more error protection bits of the first data packet; and transmitting the second data packet to the memory system based at least in part on applying the scrambling pattern to the second data packet.

Aspect 2: The method, apparatus, or non-transitory computer-readable medium of aspect 1, further including operations, features, circuitry, logic, means, or instructions, or any combination thereof for applying a second scrambling pattern to the first data packet, where the scrambling pattern applied to the second data packet is different than the second scrambling pattern applied to the first data packet, where transmitting the first data packet is based at least in part on applying the second scrambling pattern.

Aspect 3: The method, apparatus, or non-transitory computer-readable medium of aspect 2, further including operations, features, circuitry, logic, means, or instructions, or any combination thereof for determining one or more characteristics of data patterns that are associated with errors introduced into data communicated over a communication link between the host system and the memory system and determining that a data pattern of the data bits has at least one of the one or more characteristics, where the second scrambling pattern is applied to the first data packet based at least in part on the data pattern having at least one of the one or more characteristics.

Aspect 4: The method, apparatus, or non-transitory computer-readable medium of any of aspects 2 through 3, further including operations, features, circuitry, logic, means, or instructions, or any combination thereof for transmitting an indication of the second scrambling pattern to the memory system based at least in part on applying the second scrambling pattern to the first data packet and transmitting an indication of the scrambling pattern to the memory system based at least in part on applying the scrambling pattern.

Aspect 5: The method, apparatus, or non-transitory computer-readable medium of any of aspects 2 through 4, further including operations, features, circuitry, logic, means, or instructions, or any combination thereof for applying, based at least in part on the second data packet being a retransmission of the data bits and the one or more error protection bits, the second scrambling pattern to a third data packet that includes second data bits and one or more second error protection bits and transmitting the third data packet to the memory system based at least in part on applying the second scrambling pattern to the third data packet.

Aspect 6: The method, apparatus, or non-transitory computer-readable medium of any of aspects 2 through 5, further including operations, features, circuitry, logic, means, or instructions, or any combination thereof for applying, based at least in part on applying the scrambling pattern to the second data packet, the scrambling pattern to a third data packet that includes second data bits and one or more second error protection bits and transmitting the third data packet to the memory system based at least in part on applying the scrambling pattern to the third data packet.

Aspect 7: The method, apparatus, or non-transitory computer-readable medium of any of aspects 1 through 6, further including operations, features, circuitry, logic, means, or instructions, or any combination thereof for determining one or more characteristics of data patterns that are associated with errors introduced into data communicated over a communication link between the host system and the memory system and selecting the scrambling pattern based at least in part on determining that a data pattern of the data bits has at least one of the one or more characteristics.

Aspect 8: The method, apparatus, or non-transitory computer-readable medium of aspect 7, further including operations, features, circuitry, logic, means, or instructions, or any combination thereof for transmitting an indication of the scrambling pattern to the memory system based at least in part on applying the scrambling pattern to the first data packet.

Aspect 9: The method, apparatus, or non-transitory computer-readable medium of any of aspects 1 through 8, further including operations, features, circuitry, logic, means, or instructions, or any combination thereof for generating the one or more error protection bits based at least in part on the data bits, where the one or more error protection bits include CRC bits or error correction code (ECC) bits.

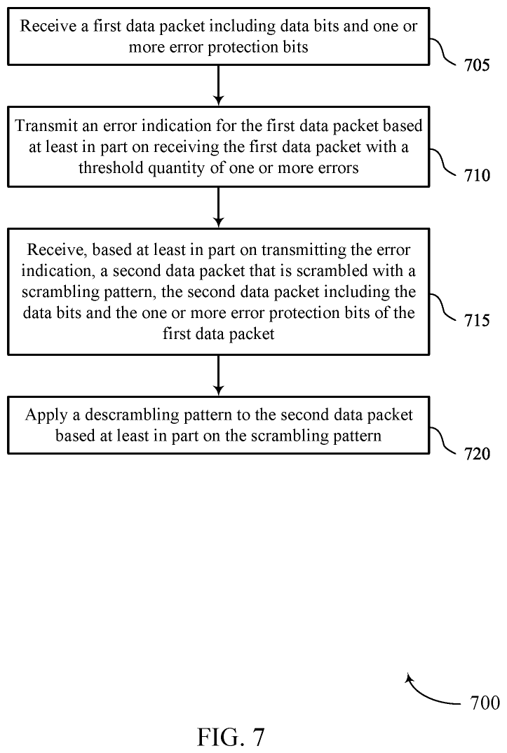

FIG. 7 shows a flowchart illustrating a method 700 that supports dynamic scrambling for wired communications between systems in accordance with examples as disclosed herein. The operations of method 700 may be implemented by a memory system or its components as described herein. For example, the operations of method 700 may be performed by a memory system as described with reference to FIGS. 1 through 3 and 5. In some examples, a memory system may execute a set of instructions to control the functional elements of the device to perform the described functions. Additionally, or alternatively, the memory system may perform aspects of the described functions using special-purpose hardware.

At 705, the method may include receiving a first data packet including data bits and one or more error protection bits. In some examples, aspects of the operations of 705 may be performed by a communication component 525.

At 710, the method may include transmitting an error indication for the first data packet based at least in part on receiving the first data packet with a threshold quantity of one or more errors. In some examples, aspects of the operations of 710 may be performed by a communication component 525.

At 715, the method may include receiving, based at least in part on transmitting the error indication, a second data packet that is scrambled with a scrambling pattern, the second data packet including the data bits and the one or more error protection bits of the first data packet. In some examples, aspects of the operations of 715 may be performed by a communication component 525.

At 720, the method may include applying a descrambling pattern to the second data packet based at least in part on the scrambling pattern. In some examples, aspects of the operations of 720 may be performed by a scrambling component 530.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 10: A method, apparatus, or non-transitory computer-readable medium including operations, features, circuitry, logic, means, or instructions, or any combination thereof for receiving a first data packet including data bits and one or more error protection bits; transmitting an error indication for the first data packet based at least in part on receiving the first data packet with a threshold quantity of one or more errors; receiving, based at least in part on transmitting the error indication, a second data packet that is scrambled with a scrambling pattern, the second data packet including the data bits and the one or more error protection bits of the first data packet; and applying a descrambling pattern to the second data packet based at least in part on the scrambling pattern.

Aspect 11: The method, apparatus, or non-transitory computer-readable medium of aspect 10, further including operations, features, circuitry, logic, means, or instructions, or any combination thereof for applying a second descrambling pattern to the first data packet, where the descrambling pattern applied to the second data packet is different than the second descrambling pattern applied to the first data packet.

Aspect 12: The method, apparatus, or non-transitory computer-readable medium of aspect 11, further including operations, features, circuitry, logic, means, or instructions, or any combination thereof for receiving an indication of a second scrambling pattern associated with the second descrambling pattern and selecting the second descrambling pattern based at least in part on the indication of the second scrambling pattern.

Aspect 13: The method, apparatus, or non-transitory computer-readable medium of any of aspects 11 through 12, further including operations, features, circuitry, logic, means, or instructions, or any combination thereof for receiving a third data packet after applying the descrambling pattern to the second data packet, the third data packet including second data bits and one or more second error protection bits and applying the second descrambling pattern to the third data packet based at least in part on the second data packet being a retransmission of the data bits and the one or more error protection bits.

Aspect 14: The method, apparatus, or non-transitory computer-readable medium of any of aspects 11 through 13, further including operations, features, circuitry, logic, means, or instructions, or any combination thereof for receiving a third data packet after applying the descrambling pattern to the second data packet, the third data packet including second data bits and one or more second error protection bits and applying the descrambling pattern to the third data packet.

Aspect 15: The method, apparatus, or non-transitory computer-readable medium of any of aspects 10 through 14, further including operations, features, circuitry, logic, means, or instructions, or any combination thereof for receiving an indication of the scrambling pattern applied to the second data packet, where the descrambling pattern is applied based at least in part on the indication.

Aspect 16: The method, apparatus, or non-transitory computer-readable medium of any of aspects 10 through 15, further including operations, features, circuitry, logic, means, or instructions, or any combination thereof for determining that the first data packet was received with the threshold quantity of one or more errors based at least in part on the one or more error protection bits, where the one or more error protection bits include CRC bits or error correction code (ECC) bits.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “isolated” may refer to a relationship between components in which signals are not presently capable of flowing between the components. Components are isolated from each other if there is an open circuit between them. For example, two components separated by a switch that is positioned between the components are isolated from each other when the switch is open. When a component isolates two components, the component may initiate a change that prevents signals from flowing between the other components using a conductive path that previously permitted signals to flow.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method at a host system, comprising:
transmitting a first data packet to a memory system, the first data packet comprising data bits and one or more error protection bits;
receiving an error indication for the first data packet, the error indication indicating that the memory system received the first data packet with a threshold quantity of one or more errors;
applying, based at least in part on receiving the error indication, a scrambling pattern to a second data packet that comprises the data bits and the one or more error protection bits of the first data packet; and
transmitting the second data packet to the memory system based at least in part on applying the scrambling pattern to the second data packet.

2. The method of claim 1, further comprising:
applying a second scrambling pattern to the first data packet, wherein the scrambling pattern applied to the second data packet is different than the second scrambling pattern applied to the first data packet, wherein transmitting the first data packet is based at least in part on applying the second scrambling pattern.

3. The method of claim 2, further comprising:
determining one or more characteristics of bit patterns that are associated with errors introduced into data communicated over a communication link between the host system and the memory system; and
determining that a bit pattern of the data bits has at least one of the one or more characteristics, wherein the second scrambling pattern is applied to the first data packet based at least in part on the bit pattern having at least one of the one or more characteristics.

4. The method of claim 2, further comprising:
transmitting an indication of the second scrambling pattern to the memory system based at least in part on applying the second scrambling pattern to the first data packet; and
transmitting an indication of the scrambling pattern to the memory system based at least in part on applying the scrambling pattern.

5. The method of claim 2, further comprising:
applying, based at least in part on the second data packet being a retransmission of the data bits and the one or more error protection bits, the second scrambling pattern to a third data packet that comprises second data bits and one or more second error protection bits; and
transmitting the third data packet to the memory system based at least in part on applying the second scrambling pattern to the third data packet.

6. The method of claim 2, further comprising:
applying, based at least in part on applying the scrambling pattern to the second data packet, the scrambling pattern to a third data packet that comprises second data bits and one or more second error protection bits; and
transmitting the third data packet to the memory system based at least in part on applying the scrambling pattern to the third data packet.

7. The method of claim 1, further comprising:
determining one or more characteristics of bit patterns that are associated with errors introduced into data communicated over a communication link between the host system and the memory system; and
selecting the scrambling pattern based at least in part on determining that a bit pattern of the data bits has at least one of the one or more characteristics.

8. The method of claim 7, further comprising:
transmitting an indication of the scrambling pattern to the memory system based at least in part on applying the scrambling pattern to the first data packet.

9. The method of claim 1, further comprising:
generating the one or more error protection bits based at least in part on the data bits, wherein the one or more error protection bits comprise cyclic redundancy check (CRC) bits or error correction code (ECC) bits.

10. A method at a memory system, comprising:
receiving a first data packet comprising data bits and one or more error protection bits;
transmitting an error indication for the first data packet based at least in part on receiving the first data packet with a threshold quantity of one or more errors;
receiving, based at least in part on transmitting the error indication, a second data packet that is scrambled with a scrambling pattern, the second data packet comprising the data bits and the one or more error protection bits of the first data packet; and
applying a descrambling pattern to the second data packet based at least in part on the scrambling pattern.

11. The method of claim 10, further comprising:
applying a second descrambling pattern to the first data packet, wherein the descrambling pattern applied to the second data packet is different than the second descrambling pattern applied to the first data packet.

12. The method of claim 11, further comprising:
receiving an indication of a second scrambling pattern associated with the second descrambling pattern; and
selecting the second descrambling pattern based at least in part on the indication of the second scrambling pattern.

13. The method of claim 11, further comprising:
receiving a third data packet after applying the descrambling pattern to the second data packet, the third data packet comprising second data bits and one or more second error protection bits; and
applying the second descrambling pattern to the third data packet based at least in part on the second data packet being a retransmission of the data bits and the one or more error protection bits.

14. The method of claim 11, further comprising:
receiving a third data packet after applying the descrambling pattern to the second data packet, the third data packet comprising second data bits and one or more second error protection bits; and
applying the descrambling pattern to the third data packet.

15. The method of claim 10, further comprising:
receiving an indication of the scrambling pattern applied to the second data packet, wherein the descrambling pattern is applied based at least in part on the indication.

16. The method of claim 10, further comprising:
determining that the first data packet was received with the threshold quantity of one or more errors based at least in part on the one or more error protection bits, wherein the one or more error protection bits comprise cyclic redundancy check (CRC) bits or error correction code (ECC) bits.

17. A non-transitory computer-readable medium storing code, the code comprising instructions executable by one or more processors to:
transmit a first data packet to a memory system, the first data packet comprising data bits and one or more error protection bits;
receive an error indication for the first data packet, the error indication indicating that the memory system received the first data packet with a threshold quantity of one or more errors;
apply, based at least in part on receiving the error indication, a scrambling pattern to a second data packet that comprises the data bits and the one or more error protection bits of the first data packet; and
transmit the second data packet to the memory system based at least in part on applying the scrambling pattern to the second data packet.

18. The non-transitory computer-readable medium of claim 17, wherein the instructions are further executable by the one or more processors to:
apply a second scrambling pattern to the first data packet, wherein the scrambling pattern applied to the second data packet is different than the second scrambling pattern applied to the first data packet, wherein transmitting the first data packet is based at least in part on applying the second scrambling pattern.

19. The non-transitory computer-readable medium of claim 18, wherein the instructions are further executable by the one or more processors to:
determine one or more characteristics of bit patterns that are associated with errors introduced into data communicated over a communication link between a host system and the memory system; and
determine that a bit pattern of the data bits has at least one of the one or more characteristics, wherein the second scrambling pattern is applied to the first data packet based at least in part on the bit pattern having at least one of the one or more characteristics.

20. The non-transitory computer-readable medium of claim 18, wherein the instructions are further executable by the one or more processors to:
transmit an indication of the second scrambling pattern to the memory system based at least in part on applying the second scrambling pattern to the first data packet; and
transmit an indication of the scrambling pattern to the memory system based at least in part on applying the scrambling pattern.
